(19) United States
(12) Patent Application Publication
(10) Pub. No.: US 2022/0356825 A1
(43) Pub. Date: Nov. 10, 2022

(54) COMPOSITION FOR CLEANING DPF FILTERS FOR DIESEL ENGINE EXHAUST GASES AND METHOD FOR CLEANING THE SAME

(71) Applicant: HEMING-BANAT DOO, Bela Crkva (RS)

(72) Inventor: Ilija VUJOVIC, Bela Crkva (RS)

(73) Assignee: HEMING-BANAT DOO, Bela Crkva (RS)

(21) Appl. No.: 17/624,412

(22) PCT Filed: May 18, 2020
(86) PCT No.: PCT/RS2020/000005

§ 371 Date: Jan. 3, 2022

(30) Foreign Application Priority Data
Jul. 1, 2019 (RS) P-2019/0844

(51) Int. Cl. F01N 3/023; C11D 7/34; C11D 11/00; B01D 41/04

(52) U.S. Cl. CPC F01N 3/0237; C11D 7/34; C11D 11/0041; B01D 41/04

(57) ABSTRACT

The present invention relates to a chemical composition that removes accumulated impurities from a DPF in an easy and fast manner. The filter does not need to be removed from the vehicle, as cleaning is done by injecting the liquid through the temperature probe opening, and the chemical composition used is completely biodegradable. Cleaning with the chemical composition of the invention is not time consuming, is easy to perform and, results in completely purified DPF. Presented chemical composition for cleaning DPFs comprises alkyl sulfonic acid and distilled water, wherein the alkyl sulfonic acid is a short alkyl chain sulfonic acid with up to 4 carbon atoms (methane sulfonic acid, ethane sulfonic acid, propane sulfonic acid or butane sulfonic acid), with methane sulfonic acid being preferred due to its properties and availability.

### FIELD OF THE INVENTION

The invention relates to a chemical composition for cleaning diesel particulate filters (DPFs) for diesel engine exhaust gases.

### Technical Problem

A diesel particulate filter in the exhaust systems of internal combustion engines, especially diesel engines, is used for the purification of exhaust gases. The exhaust gases contain soot and ash particles that come from unburned hydrocarbons, as well as fuel and engine oil additives. To meet the stringent requirements for the soot and ash emission in the exhaust gases, it is necessary to filter the exhaust gases using a DPF.

The DPF is mounted on the exhaust manifold behind the catalyst and consists of a porous structure.

Most of the soot comes from unburned hydrocarbons from fuel, while most of the ash is derived from fuel and engine oil additives, as well as from engine wear. The ash may also come from the unfiltered catalyst in the fuel that remains during biodiesel production. The ash is composed of sulfate, sulfide, phosphate, zinc oxide, calcium, magnesium, iron, copper or nickel.

During engine operation, the exhaust gases pass through the DPF, with most of the ash and soot being retained in the filter while purified gases exit at the filter outlet.

During engine operation, increasing amounts of soot and ash particles are trapped in the filter, causing the filter to become clogged. This results in poor engine performance, i.e. loss of engine power, as well as increased fuel consumption.

Declogging of the DPF is carried out by active and passive regeneration during engine operation whereby most of the soot originating from unburned hydrocarbons is combusted, but the particles remain in the pores of the filter and accumulate. The result is reduced filtering capacity, increased pressure difference, reduced engine power, and increased fuel consumption. The accumulation of ash particles also leads to more frequent passive regeneration, which disrupts the filter pores.

To restore the satisfactory performance of the DPF, it is necessary to either replace it with a new one or clean the old DPF to remove the ash particles.

The technical problem solved by the present invention is to provide complete cleaning of the accumulated impurities from the DPF, which also delays re-clogging, after which damage to the filter structure is avoided, whereby such cleaning is easy and does not require much time.

### BACKGROUND ART

There are several techniques for cleaning DPFs. One of the methods for DPF cleaning involves the use of pulsed compressed air. The pressurized air blows through the filter from the backside, however, it takes a long time for the filter to be removed from the vehicle and the result is an insufficiently cleaned filter.

Another method is a thermal regeneration, in which the filter is also removed from the vehicle and placed in a chamber where the soot is burned at high temperatures to form the ash. The filter is then purged with air to remove the ash thus formed. This method also requires even more time and leads to incomplete cleaning of the filter, as the ash always remains partially bound to the filter and creates bridges between membranes leading to rapid re-clogging of the filter in reuse.

Some of the methods use these two methods mentioned above in combination with a vibrator or an ultrasonic machine, which is supposed to improve cleaning, however, this often causes damage to the structure inside the filter.

Some methods use a DPF cleaning solution and special washing chambers where the filter is soaked and cleaned. However, this requires expensive equipment and removal of DPF from a vehicle. The cleaning is incomplete, and the solution used for cleaning is often too aggressive, resulting in disruption of the filter compositions and subsequent poor performance in reuse, that is, insufficient filtering of exhaust gases and higher than the allowable emission of detrimental gases.

There are also methods for cleaning a DPF without removing it from the vehicle, where the filter is flushed with a cleaning solution through the temperature probe opening.

However, the composition of the solution has been shown to result in insufficient cleaning i.e. rapid re-clogging of the filter after 7,000-8,000 km of distance traveled.

Also, the solutions used for cleaning are often too aggressive which causes the filter structure to be damaged.

### SUMMARY OF THE INVENTION

The present invention relates to a chemical composition that easily and quickly removes accumulated impurities from a DPF. The filter does not need to be removed from the vehicle, as cleaning is done by injecting the liquid through the temperature probe opening, and the chemical composition used is completely biodegradable. Cleaning with presented chemical composition is not time-consuming, is easy to perform, and results in a completely cleaned filter.

The subject of present invention is a chemical composition for cleaning a DPF containing alkyl sulfonic acid and distilled water, wherein alkyl sulfonic acid is a short alkyl chain sulfonic acid of up to 4 carbon atoms (methane sulfonic acid, ethane sulfonic acid, propane sulfonic acid or butane sulfonic acid), with methane sulfonic acid being preferred due to its properties and availability. Said chemical composition is not aggressive to the materials of which the filter is composed, thus filter retains its exhaust gas purification properties after cleaning. The exhaust gas emission from the vehicle is within the permissible limits as if using a new DPF.

The chemical composition of the invention completely cleans the DPF, the purified DPF operates well on the vehicle even after 60,000 km of distance traveled, unlike the chemical compositions present on the market which remove impurities incompletely, and as a result, the filter becomes soiled again, to a useless level, after 7,000-10,000 km of distance traveled, because if the liquid does not wash the DPF well, the impurities remaining in the DPF cause new particles of soot and ash to accumulate more easily, resulting in rapid re-soiling of the DPF.

Cleaning with the chemical composition of the invention does not require additional and expensive equipment, only the compressor and the associated compressor gun are required.

After cleaning with the chemical composition of the present invention, the fuel consumption is noticeably lower and the engine exhibits better performance.

After washing the DPF with the chemical composition of the invention, the motor itself performs the cycles of active and passive regeneration, without the need for computer-generated violent regeneration.

In addition to methane sulfonic acid and distilled water, it is also possible to incorporate other ingredients into the composition of a DPF chemical cleaning agent, such as water-soluble solvents, non-ionogenic emulsifiers, metal complexing agents, etc. However, it has been shown that washing with a composition containing only methane sulfonic acid and distilled water is sufficiently effective.

Metal salts, sulfates, phosphates, and metal oxides have extremely high solubility in methane sulfonic acid solutions, compared to other organic and inorganic acids, which is exceptionally important for the application of methane sulfonic acid in DPF cleaning, which is an object of the present invention.

Also, the dissolution rate is extremely high, i.e. instantaneous, which is also important for the application of methane sulfonic acid in cleaning DPFs, thus it is possible to efficiently clean the DPF with as little as one liter of solution of methane sulfonic acid and distilled water, and by only one passage of the solution through the DPF.

Methane sulfonic acid, when compared to other strong organic and inorganic acids (HCl, H₂SO₄, etc.), is less aggressive i.e. corrosive, which is a preferred feature for the use of methane sulfonic acid in cleaning DPFs, since it does not impair the internal composition of the filter, but only effectively cleans impurities (such as ash and soot) from the filter.

These favorable properties of methane sulfonic acid solution make it possible to use the solution for washing DPFs in a fast and efficient manner.

The DPF is washed on-site, without removal from the vehicle, by injecting one liter of pressurized solution through the temperature probe opening. The temperature probe is then put back in place and the vehicle can be used. This is another advantage over other DPF cleaning techniques that require a lot of washing time, some techniques require all day, during which time the vehicle stays parked and it is not in running order.

It has been shown that the methane sulfonic acid solution in the range according to the present invention is not aggressive to the catalyst interior, that is, after washing with the corn position of the invention, the DPF retains its properties i.e. effectively purifies the exhaust gases.

Methane sulfonic acid is an acid that is naturally occurring as it is involved in the natural sulfur cycle. Also, methane sulfonic acid solutions are rapidly biodegradable, that is, completely biodegradable within 28 days. For these reasons, the chemical composition of the invention is environmentally friendly, i.e., it is not harmful to the environment.

Methane sulfonic acid solutions do not have high vapor pressure i.e. they do not have unpleasant odors, which makes them easy to use in the DPF washing process, which is another advantage compared to the solutions used so far to wash DPFs.

The composition of the cleaning agent which is a subject of the present invention comprises from 1 to 15 weight % of methane sulfonic acid, preferably 7 weight % of methane sulfonic acid. Too low concentration will result in inadequate washing i.e. incomplete washing. Excessive concentration will result in chemical degradation of the internal filter composition. Distilled water balances up to 100 weight %.

The chemical composition which is a subject of the present invention is used as follows:

When the vehicle is parked, one needs to wait until the temperature in the DPF drop below 80° C. The temperature probe of the DPF is unscrewed without removing the DPF from the vehicle. One liter of 7 weight % methane sulfonic acid solution is injected at a pressure of about 7 bars through the temperature probe opening. The injecting is performed in short cycles of 5 seconds of injecting and 5 seconds of break time.

After injection, the filter is rinsed through the same temperature probe opening with one liter of distilled water, which is injected in the same way, at a pressure of 7 bars.

The temperature probe is put back in place and screwed; the vehicle is started while keeping revs at 2500 rpm for 10 minutes, which produces a certain amount of steam and gases resulting from the combustion of impurities generated by the washing of the DPF, which accumulate during washing in the rear muffler of the exhaust system.

After combustion, the vehicle needs to be driven for 20 minutes at a speed greater than 20 km/h at more than 2000 rpm, more preferably greater than 70 km/h. This procedure is required to clean engine ECU faults.

The composition of the present invention can also be used to wash DPFs by procedures other than those mentioned above.

Also, a DPF can be efficiently washed with the composition of the invention through removing the DPF from the vehicle and washing said filter under pressure whereby the impurities are removed from the filter and accumulated in a particular container. The advantage of this method is the reduction of the exhaust gas levels generated by the combustion of accumulated impurities in the rear muffler of the exhaust system. The DPF can also be washed effectively in washing machines and bathtubs that are known and used for similar purposes.

Methods for measuring filter soiling are known. Using a car diagnostic tool connected to the vehicle's central computer, the ECU, the gas pressure at the inlet of the DPF and the gas pressure at the outlet of the DPF are read, whereby the differential pressure read on the diagnostic tool indicates the degree of DPF soiling. In the examples below, differential pressure reading was done before and after washing the filter, whereby this reading was an indication of the effectiveness of the agent of the invention in DPF washing.

Exhaust gas measurement after the cleaning of the DPF was performed by a smoke meter or an opacimeter. The measurement is based on passing a beam of light of 555 nm wavelength through the exhaust gas sample. Six consecutive measurements are made by pressing the accelerator pedal fully for 6 seconds each. The absorption coefficient K (m⁻¹) is obtained as a result of the measurement. The higher the soot content, i.e. the higher the degree of smoke in the exhaust gases, the gas absorbs more light and the absorption coefficient K is higher.

Tests with tap water instead of distilled water, which were also conducted, showed poorer results.

### DETAILED DESCRIPTION OF THE INVENTION

The invention is described in more detail in the following examples. Said examples are not limiting for the application of the disclosed invention in any way.

A common cleaning agent composition is a solution comprising 93 weight % of distilled water and 7 weight % of methane sulfonic acid.

Testing the efficiency of use on different types of vehicles was carried out by the inventor in several examples:

### Example 1. Honda CRV 2013 2.2 Diesel

The cleaning agent composition is a solution comprising 93 weight % of distilled water and 7 weight % of methane sulfonic acid.

Before washing the DPF, the vehicle was in safe mode and could not perform passive regeneration. The violent regeneration was done twice, but after 1,000 km of distance traveled, the DPF clogged again and the vehicle entered safe mode.

Condition after washing the DPF through the temperature probe without removing the DPF from the vehicle:

Differential pressure 0.4 Kpa at idle

Differential pressure 2.1 Kpa at 2000 revolutions

Exhaust gases emission K=0.0000 m⁻¹

After 60,000 km of distance traveled:

Differential pressure 0.5 Kpa at idle

Differential pressure 2.0 Kpa at 2,000 revolutions

Exhaust gases emission K=0.0000 m⁻¹

### Example 2. Honda Acord 2009 2.2 Diesel

The cleaning agent composition is 94 weight % distilled water and 6 weight % methane sulfonic acid.

Same as previous, before washing the DPF, the vehicle was in safe mode and could not perform passive regeneration. The violent regeneration was done twice, but after 1,000 km of distance traveled the DPF clogged again and the vehicle entered safe mode.

Condition after washing the DPF through the temperature probe without removing the DPF from the vehicle:

Differential pressure 0.7 Kpa at idle

Differential pressure 4 Kpa at 2500 revolutions

After 2,500 km of distance traveled:

Differential pressure 0.8 Kpa at idle

Differential pressure 5 Kpa at 2500 revolutions

### Example 3. BMW 116 2009

The cleaning agent composition is 96 weight distilled water and 4 weight % methane sulfonic acid.

Before DPF washing:

Differential pressure 7.5 Kpa at idle

Differential pressure 20 Kpa at 2000 revolutions

After washing the DPF through the temperature probe without removing the DPF from the vehicle:

Differential pressure 1.1 Kpa at idle

Differential pressure 2.7 Kpa at 2000 revolutions

In all three of these examples, after washing the DPF, the vehicles have better driving performance and the fuel consumption is lower. The vehicles by themselves enter regeneration cycles without the need for service and initiating violent regeneration.

1-14. (canceled)

15. A method for cleaning a diesel particulate filter (DPF) comprising injecting a composition comprising at least one alkyl sulfonic acid into the DPF.

16. The method according to claim 15, wherein the alkyl sulfonic acid is a C1-C4 alkyl sulfonic acid.

17. The method according to claim 15, wherein the alkyl sulfonic acid is methane sulfonic acid.

18. The method according to claim 15, wherein the alkyl sulfonic acid is methane sulfonic acid, ethane sulfonic acid, propane sulfonic acid or butane sulfonic acid, or two or more thereof.

19. The method according to claim 15 wherein the composition further comprises distilled water.

20. The method according to claim 19, wherein the composition comprises 1-15 weight % of at least one alkyl sulfonic acid with the balance being distilled water up to 100 weight %.

21. The method according to claim 19, wherein the composition comprises 7 weight % of at least one alkyl sulfonic acid with the balance being distilled water up to 100 weight %.

22. The method according to claim 16, wherein the composition comprises 7 weight % of methane sulfonic acid with the balance being distilled water up to 100 weight %.

23. The method according to claim 16, wherein the composition comprises 6 weight % of methane sulfonic acid with the balance being distilled water up to 100 weight %.

24. The method according to claim 16, wherein the composition comprises 4 weight % of methane sulfonic acid with the balance being distilled water up to 100 weight %.

25. The method according to claim 15, wherein the composition further comprises water-soluble solvents, non-ionogenic emulsifiers, metal complexing agents or a combination thereof.

26. The method according to according to claim 15 wherein the method comprises the steps:
unscrewing the temperature probe of the DPF,
injecting the composition through the temperature probe opening, and
subsequently injecting distilled water under pressure through the same temperature probe opening.

27. The method according to claim 15, wherein the method comprises the steps:
unscrewing the temperature probe of the DPF,
injecting the composition comprising 1 to 15% methane sulfonic acid through the temperature probe opening, and
subsequently injecting distilled water under pressure through the same temperature probe opening.

28. The method according to claim 27 wherein the pressure is about 7 bars.

29. The method according to claim 27 wherein the methane sulfonic acid solution is 7 weight % solution.

30. The method according to claim 27, wherein the method further comprises:
after injecting distilled water, putting the temperature probe back in place and screwing the temperature probe on the DPF,
then starting the vehicle while keeping revs at 2500 rpm for 10 minutes, and
after that, driving the vehicle for 20 minutes at a speed exceeding 20 km/h at more than 2000 rpm.

31. The method according to claim 30 wherein the speed is greater than 70 km/h.3127.

32. The method according to claim 27, wherein the injection of the pressurized composition is performed in short cycles of 5 seconds of injecting and 5 seconds of break time.

33. The method according to claim 27, wherein the DPF is removed from the vehicle and washed under pressure whereby the impurities are removed from the filter.
